(19) United States
(12) Patent Application Publication
(10) Pub. No.: US 2005/0167984 A1
(43) Pub. Date: Aug. 4, 2005

(54) Shrinkage-free sealing structure of heat pipe

(76) Inventor: Hul-Chun Hsu, Taichung (TW)

Correspondence Address: Yi-WenTseng, 4331 Stevens Battle Lane, Fairfax, VA, 22033, US

(21) Appl. No.: 10/770,473

(22) Filed: Feb. 4, 2004

(51) Int. Cl. F16L 13/14

(52) U.S. Cl. 285/382

(57) ABSTRACT

A shrinkage-free sealing structure of a heat pipe. The sealing structure is in the form of a double-layered structure formed by transversely pressing a first side of an open end of the heat pipe towards a second side of the open end for at least once and transversely pressing the second side towards the first side for at least once. Preferably, the double-layered structure has a semi-circular cross section after the first side is pressed towards the second side of the open end, and the sealing structure has an arrowhead structure after the second side is pressed towards the first side.

### BACKGROUND OF THE INVENTION

The present invention relates to a shrinkage-free sealing structure of a heat pipe, and more particular, to a method which seals one open end of a heat pipe without performing shrinkage process thereof.

For the majority of electronic products, the performance depends on the operation processing speed, while the heat dissipation is a consequence of the operation processing speed. In the example of a central processing unit (CPU) of a computer motherboard, transmission of various command signals and calculation program parameters are performed with very high speed to generate significant heat. The heat adversely affects the performance and reduces the operation speed of the central processing unit. The operation may even be halted when the central processing unit is over heated. Therefore, heat dissipation devices are required to keep the electronic products working under a tolerable temperature range to avoid interruption or termination of operation.

To enhance heat dissipation efficiency, highly thermal conductive heat pipes operative to absorb and dissipate heat efficiency have been used in the heat dissipation devices. A heat pipe is in the form of a tube with one closed end and one open end. A wick structure is installed in the heat pipe and a working fluid is introduced into the heat pipe, followed by the process of sealing the open end. When the heat pipe is in contact with the electronic products, the heat absorbing end absorbs the heat from the electronic products, such that a phase transition from the liquid state to the gas state occurs to the working fluid. After flowing to the cooling end of the heat pipe, the gaseous working fluid is then condensed back to the liquid state and re-flows back to the heat absorbing end by the capillary effect provided by the wick structure. Therefore, the circulation and phase transition of the working fluid irritated in the heat pipe provides enhanced heat dissipation performance, such that the electronic product can always operate under a uniform and working temperature

To ensure the quality and functionality of the heat pipe, the sealed end of the heat pipe is further subject to a soldering process. As shown in FIG. 1, the conventional sealing structure of a heat pipe is performed by shrinking the open end portion of the heat pipe 10a into a shrunk end portion 100a, and a sealing module is used to clamp the terminus of the shrunk end portion 100a, such that a flattened region 101a is formed. The edge of the flattened region 101a is then soldered to ensure a air-tight sealing effect.

However, the objective for shrinking the end portion 10a into the shrunk end portion 100a is to decrease the volume and area of the sealing structure, such that it is advantageous for the subsequent soldering process. However, as the shape of the wick structure proximal to the shrunk end portion 10a is unstable, the working fluid has to be filled manually. Therefore, the fabrication process is laborious and costly. The wick structure installed and the working fluid filled after the shrunk end portion 100a is formed will become very difficult.

To resolve the problems caused by the conventional heat pipe structure as described above, the Applicant, with many years of experience in this field, has developed a shrinkage-free sealing structure of heat pipe as described as follows

### BRIEF SUMMARY OF THE INVENTION

The present invention provides a shrinkage-free sealing structure of a heat pipe to resolve the problems of the conventional sealing structure and to reduce the cost, and the soldering process of the sealing structure is easier compared to the conventional structure.

The shrinkage-free sealing structure of a heat pipe provided by the present invention comprises a double-layered structure formed by transversely pressing a first side of an open end of the heat pipe towards a second side of the open end for at least once and transversely pressing the second side towards the first side for at least once. Preferably, the double-layered structure has a semi-circular cross section after the first side is pressed towards the second side of the open end, and the sealing structure has an arrowhead structure after the second side is pressed towards the first side.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

These, as well as other features of the present invention, will become apparent upon reference to the drawings wherein:

FIG. 1 shows a side view of a conventional heat pipe;

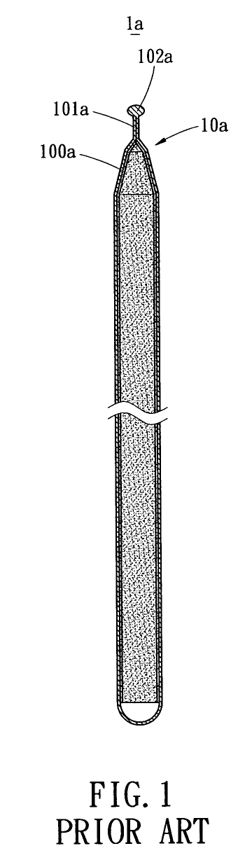

FIG. 2 shows a perspective view of a heat pipe having a sealing structure provided by the present invention;

FIG. 3 shows a top view of the sealing structure;

FIG. 4 shows a top view a press module for flattening the open end of the heat pipe at a first stage;

FIG. 5 shows a perspective view of the heat pipe after the first stage;

FIGS. 6 to 8 show top views of another press module for flattening the open end of the heat pipe at a second stage;

FIG. 9 shows a perspective view of the heat pipe after the second stage; and

FIG. 10 shows a cross sectional view of a modification the sealing structure.

### DETAILED DESCRIPTION OF THE INVENTION

Reference will now be made in detail to the preferred embodiments of the present invention, examples of which are illustrated in the accompanying drawings. Wherever possible, the same reference numbers are used in the drawings and the description to refer to the same or like parts.

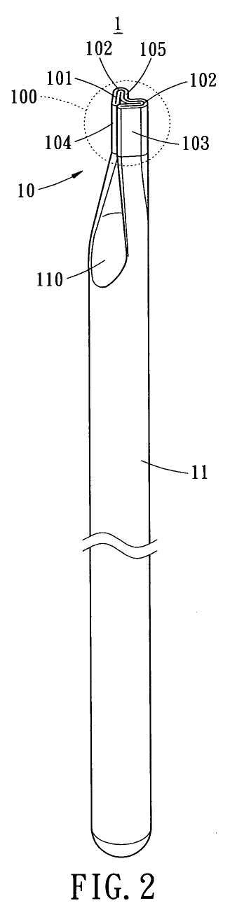

Referring to FIG. 2, a perspective view of a sealing structure provided by the present invention is illustrated. The heat pipe 1 includes an open end 10 to be sealed by the sealing structure, such that the interior of the heat pipe is air-tight, and the working fluid can properly perform phase transition, allowing a normal operation of the heat pipe.

To prepare the sealing structure, the open end 10 of the heat pipe 1 is processed as follows.

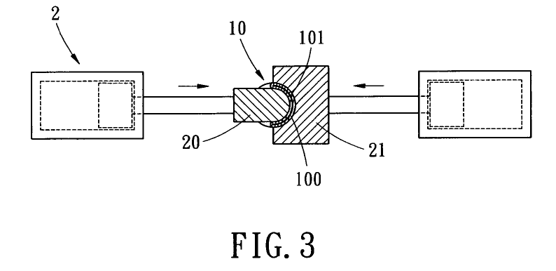

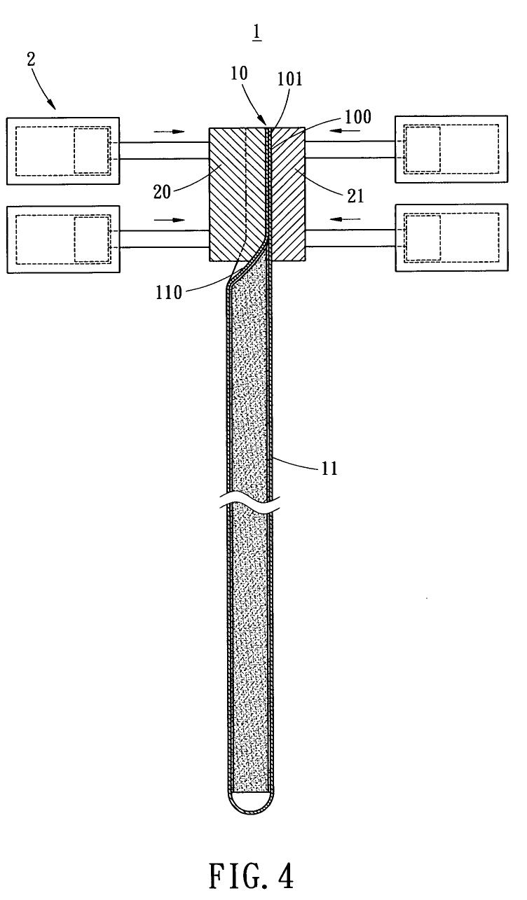

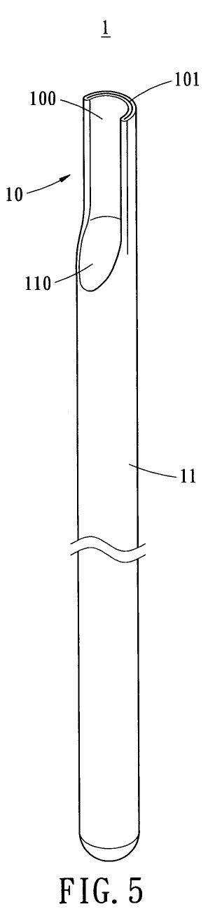

As shown in FIGS. 3 and 4, the open end 10 of the heat pipe 1 is disposed in a press module 2 which includes a first mold 20 and a second mold 21. The first mold 20 has a convex semi-circular contact, while the second mold 21 has a concave semi-circular contact. Therefore, by placing the open end 10 of the vertically extending heat pipe between the first mold 20 and the second mold 21 and pressing the first mold 20 towards the second mold 5, one half of the sidewall at the open end 10 is pressed towards the other half of the sidewall. As shown in FIG. 5, the open end 10 is pressed into a shape with a double-layered semi-circular cross section.

Thereby, a recess portion 100 is formed at the half sidewall that has been pressed towards the other half, and a bent sidewall 110 is formed between the pressed open end 10 and the bulk body of the heat pipe 1. Preferably, these two half sidewall walls are spaced from each other by a narrow curved slit 101 as shown in FIG. 5.

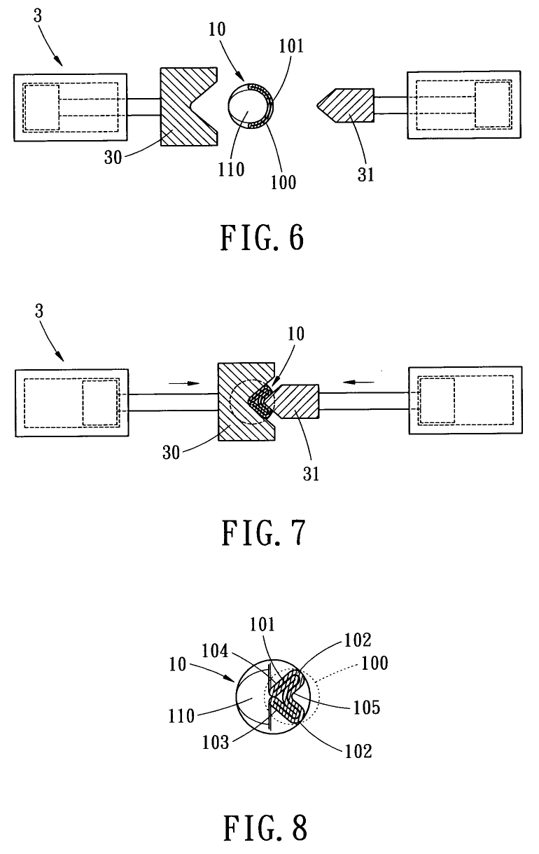

As shown in FIGS. 6-7, the heat pipe 1 as shown in FIG. 5 is further placed in a press module 3. Similarly, the heat pipe 1 extends vertically, while the pressed open end 10 is placed between a first mold 30 and a second mold 31. Preferably, the first mold 30 has a recessed triangular contact, while the second mold 331 has a protruding triangular contact. The convex portion of the open end 10 is placed towards the second mold 31, while the concave portion of the open end 10 is facing the first mold 30 when the first and second molds 30 and 31 are pressed against each other. As a result, the open end 10 is processed into a sealing structure that has a double-layered arrowhead cross section as shown in FIG. 7.

As shown in FIGS. 2 and 8, the sealing structure can be divided into a first flattened portion 103 and a second flattened portion 104 inclined with each other. The first and second flattened portions 103 and 104 each has one end in abutting contact with each other and the other end connected to a bent third flattened portion 105 at the bending point 102.

In this embodiment, the second mold 31 of the press module 3 has a protruding triangular contact, such that the third flattened portion 105 is bent into two portions towards the first and second flattened portions 103 and 104, respectively. When the second mold 31 is in the form of a flat contact, a sealing structure with a triangular cross section will be formed instead.

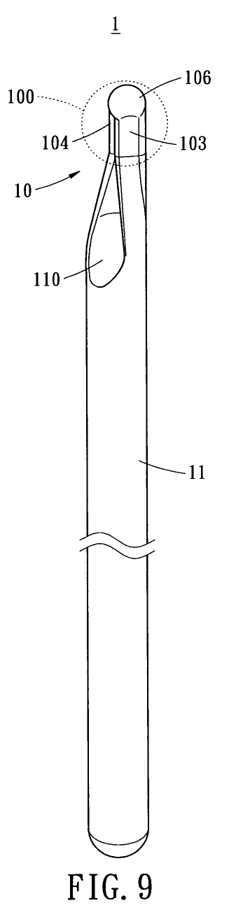

As shown in FIG. 9, when the heat pipe 1 is processed as shown in FIG. 2 or FIG. 8, the narrow slit 101 at the pressed sidewall portion 100 can be sealed by forming a covering portion 106 by brazing, soldering or welding. Therefore, the air-tightness of the heat pipe 1 can be ensured.

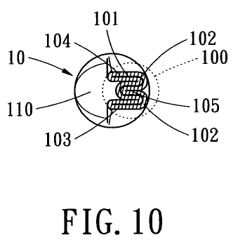

Further, as shown in FIG. 10, the open end 10 as shown in FIGS. 2 and 8 can be further processed. That is, the bending portions 102 of both the first and second flattened portions 103 and 104 can be pressed towards each other to form a sealing structure with a W-shape cross section.

Accordingly, the sealing structure provided by the present invention has at least the following advantages.

1. Without the thermal shrinking process, the open end can be sealed with a smaller cross section. Therefore, the problems of the conventional structure are resolved, the cost is reduced, and the quality is enhanced.

2. As the open end is pressed with a smaller cross section, the time spent on soldering process is shortened.

This disclosure provides exemplary embodiments of the present invention. The scope of this disclosure is not limited by these exemplary embodiments. Numerous variations, whether explicitly provided for by the specification or implied by the specification, such as variations in shape, structure, dimension, type of material or manufacturing process may be implemented by one of skill in the art in view of this disclosure.

1. A shrinkage-free sealing structure of a heat pipe, comprising a double-layered structure formed by transversely pressing a first side of an open end of the heat pipe towards a second side of the open end for at least once and transversely pressing the second side towards the first side for at least once.

2. The sealing structure of claim 1, wherein the double-layered structure has an arrowhead cross section.

3. The sealing structure of claim 1, wherein the double-layered structure has a narrow slit therein.

4. The sealing structure of claim 3, further comprising a covering portion sealing the narrow slit.

5. The sealing structure of claim 4, wherein the covering portion is formed by brazing, soldering or welding.

6. The sealing structure of claim 1, wherein the double-layered structure has a W-shape cross section.

7. A method of forming a sealing structure at an open end of a heat pipe, comprising:
a) pressing one side of the open end towards the other side of the open end to form a double-layered structure with one concave side and one convex side; and
b) pressing the convex side towards the concave side to form the sealing structure.

8. The method of claim 7, wherein step (a) further comprises using a mold having a concave contact and a mold having a convex contact to press the open end.

9. The method of claim 8, wherein step (b) further comprises using a mold having a recessed triangular contact is placed at the concave side and a mold having a protruding triangular contact is placed at the convex side for pressing the double-layer structure.

10. The method of claim 7, further comprising the step of forming a covering portion to cover the sealing structure.

11. The method of claim 10, wherein the covering portion is formed by brazing, soldering or welding.

12. The method of claim 7, further comprising the step of pressing two opposing sides of the sealing structure against each other after step (b).

13. The method of claim 7, wherein step (a) further comprises pressing the open end into the double-layered structure having a semi-circular cross section.

14. The method of claim 13, wherein step (b) further comprises pressing the open end into the double-layered structure having an arrowhead cross section.
